(19) United States
(12) Patent Application Publication
(10) Pub. No.: US 2019/0159548 A1
(43) Pub. Date: May 30, 2019

(54) SHOE INSOLE AND GRIP MATERIAL AFFIXABLE THERETO

(71) Applicant: STORELLI SPORTS, INC., Brooklyn, NY (US)

(72) Inventors: Claudio STRELLI, New York, NY (US); Thomas Vincent MARCHESI, New York, NY (US); Sarah BLASER, Brooklyn, NY (US); Hendrik Mark Francis SCHERMERS, Brooklyn, NY (US)

(73) Assignee: Storelli Sports, Inc., Broolyn, NY (US)

(21) Appl. No.: 16/097,713

(22) PCT Filed: May 9, 2017
(86) PCT No.: PCT/US2017/031803

§ 371 Date: Oct. 30, 2018

Related U.S. Application Data
(60) Provisional application No. 62/448,217, filed on Jan. 19, 2017.
(60) Provisional application No. 62/333,603, filed on May 9, 2016.

(51) Int. Cl. A43B 17/00; A43B 17/14; B32B 7/12; B29D 35/12

(52) U.S. Cl. CPC A43B 17/006; A43B 17/14; A43B 5/02; B29D 35/122; B32B 7/12

(57) ABSTRACT

An insole that includes grip fabric that has a high coefficient of friction to prevent slippage within a shoe. The insole can include a heel portion that extends from the base and the grip fabric can be applied to at least regions of the heel portion as well.

This patent application claims benefit under 35 U.S.C. § 119 to U.S. Provisional Patent Application No. 62/333,603, filed May 9, 2016 and U.S. Provisional Patent Application No. 62/448,217, filed Jan. 19, 2017, which are hereby incorporated by reference in their entirety as part of the present disclosure.

### FIELD OF THE INVENTION

The present invention relates generally to a shoe, shoe insoles and grip fabric that can be applied directly to an interior of the shoe and/or to a shoe insole, and more specifically to synthetic fiber grip material that has a high coefficient of friction (or high friction force) under both dry and wet conditions and a shoe and/or a shoe insole that is covered at least in part with the synthetic fiber grip material to maintain static contact with other fabrics (e.g., sock) or directly with skin of a foot when the fabric and/or skin under both dry and wet conditions to stabilize an individual's foot within a shoe (e.g., an athletic shoe), increasing reaction time and reducing the risk of injury.

### BACKGROUND OF THE INVENTION

Individual's commonly wear socks in conjunction with athletic shoes that have insoles arranged therein. However, an individual's foot and the sock, commonly worn over the individual's foot, rarely fill the entirety of an interior of the shoe so that the individual's foot does not slide within the shoe.

Moreover, fabric covering known insoles for an athletic shoe regularly has low coefficient of friction and, thus, the insole does not grip a sock and/or foot of an individual wearing the shoe. This often leads to slippage of the individual's foot and/or sock over the insole within the shoe caused by the lack of friction between the sock and/or foot and the insole. As a result of slippage within a shoe, an individual's reaction time to an event is typically slower by a fraction of seconds, which can prove critical for athletes. Also, as a result of slippage within a shoe, an individual can sustain various injuries (e.g., movement of the foot within the shoe can result in the twisting of an ankle and/or knee resulting in sprains, ligament or other injuries such as continuous hitting of the toes against the inner front part of the shoe when hiking or running downhill).

### SUMMARY OF THE INVENTION

The present invention is directed to an insole that is comprised of a core or base and a synthetic grip fabric that comprises a high coefficient of friction that can extend over select regions of the top of the base or the entirety of the top of the base of the insole to increase friction between the insole and an individual's foot directly or an individual's foot indirectly via a sock under both dry and wet conditions. Alternatively, or in addition to the insole, the synthetic grip fabric can be applied at least to regions of an internal cavity of a shoe to increase friction between an individual's foot and the shoe. The increased friction between an individual's foot and an insole of a shoe or shoe directly greatly reduces slippage and/or sliding of the individual's foot within the shoe and prevents the individual's heel from lifting within the shoe. This in turn increases reactivity time and reduces the risk of injury. In an embodiment, the shoe can be an athletic shoe and the insole can be designed for use with the athletic shoe.

In an embodiment, the core or base of the insole can be made of polyurethane foam or sponge that is molded into an ergonomic shape to absorb shock from the weight of an individual.

In an embodiment, the core or base of the insole is covered in at least in part with the synthetic grip material (e.g., ergonomically placed at balls of feet, toes, heel, etc.). In an embodiment, the entirety of the core or base of the insole is covered with synthetic grip fabric to enhance the friction between the insole and an individual's foot or sock the individual is wearing. That is, the grip fabric ensures static contact between the insole and other fabrics (e.g., socks) or directly with human skin under both dry and wet conditions. In an embodiment, the grip fabric is poly micro-suede. In an embodiment, the grip fabric is a nonwoven blend of polyester and nylon that is brushed. The fabric is heated and turned into a sheet of material that is then brushed to give the material nap. The synthetic fabric can have low levels of elasticity. In an embodiment, the grip material has a thickness of less than about 2 mm and preferably less than about 1 mm.

In an embodiment, the grip fabric is applied to the top of the core or base by lamination to permanently fix to the grip fabric to regions or the entirely of base of the insole. In an embodiment, the grip fabric is packaged as roll, a sheet or sheets of releasably fixable synthetic fabric where a top side of the grip fabric has a high coefficient of friction and the bottom side of the synthetic grip fabric has pressure-sensitive adhesive applied thereto with a removable covering layer extending over the adhesive. When the covering layer is removed to expose the pressure-sensitive adhesive, the strip or sheet of the grip fabric can be arranged over a region, regions or the entirety of the top of the core or base or directly to a region or regions of an internal cavity of a shoe. Then, by applying pressure to the top surface of the grip fabric, the grip fabric can be releasably fixed to the base of the insole and/or directly to a shoe. As such, the grip fabric can be applied either at a factory or by an end user.

In an embodiment, the insole can include a heel portion that extends from the base of the insole. The heel portion can have a first leg that extends from a first side of the base and a second leg that extends from a second side of the base. The synthetic grip material can be arranged at least in part over a surface of the heel portion to aid in preventing the heel of a foot from lifting within the shoe. The heel portion can include a protrusion which extends outwardly from the shoe.

### BRIEF DESCRIPTION OF THE DRAWINGS

FIG. 1 shows an embodiment of an insole of the present invention arranged within an athletic shoe;

FIG. 2 shows a cross-sectional view of the insole of FIG. 1 and a foot arranged within an athletic shoe;

FIG. 3 is a front perspective view of the insole of FIG. 1;

FIG. 4 is a rear perspective view of the insole of FIG. 1;

FIG. 5 is a side view of the insole of FIG. 1;

FIG. 6 is a top view of the insole of FIG. 1;

FIG. 7 is a second front perspective view of the insole of FIG. 1;

FIG. 8 is a second rear perspective view of the insole of FIG. 1;

FIG. 9 shows a bottom view of an embodiment of a molded insole;

FIG. 10 shows an embodiment of grip fabric that is arranged on the insole and maintains a high coefficient of friction even when wet;

FIG. 11 shows an embodiment of the grip fabric of FIG. 10 being arranged on the base of the insole of FIG. 9;

FIG. 12 shows embodiments of grip fabric used during testing;

FIGS. 13-16 show the results during static and dynamic friction testing of the grip fabrics of FIG. 12;

FIG. 17 shows a comparison of the coefficient of friction of an embodiment of grip material and insole of the present invention versus a standard insole;

FIG. 18 shows a comparison of the force of movement of an embodiment of grip material and insole of the present invention versus a standard insole; and

FIG. 19 shows a comparison of the contact time of an embodiment of grip material and insole of the present invention versus a standard insole.

### DETAILED DESCRIPTION OF EMBODIMENTS OF THE INVENTION

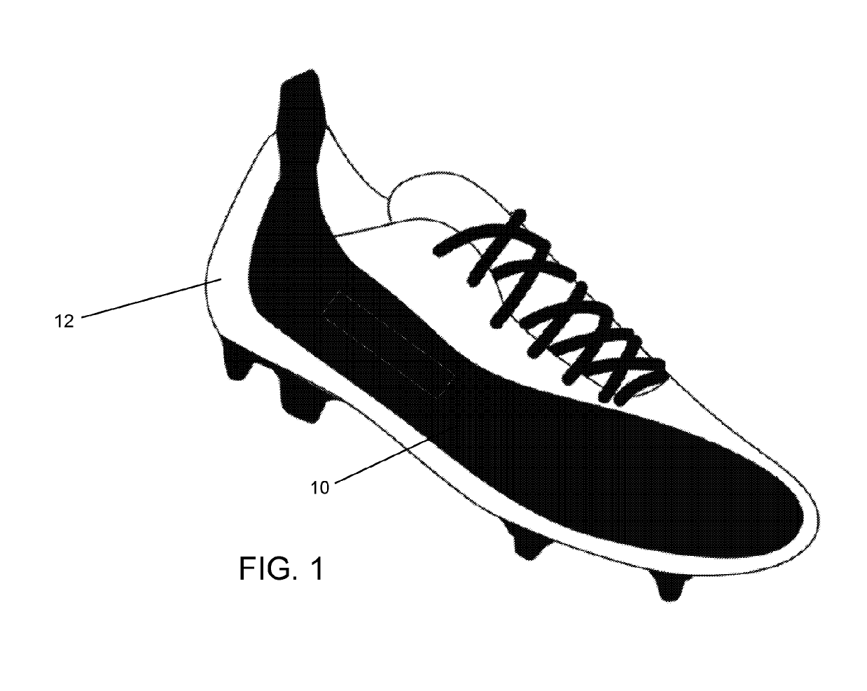

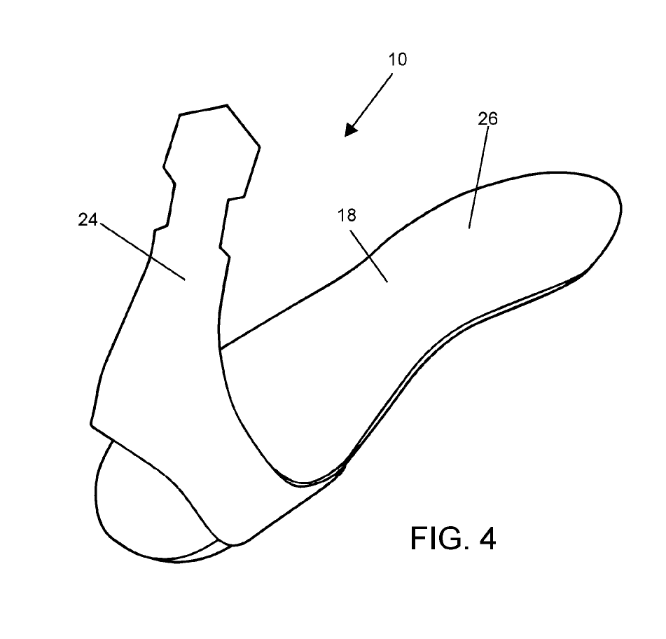

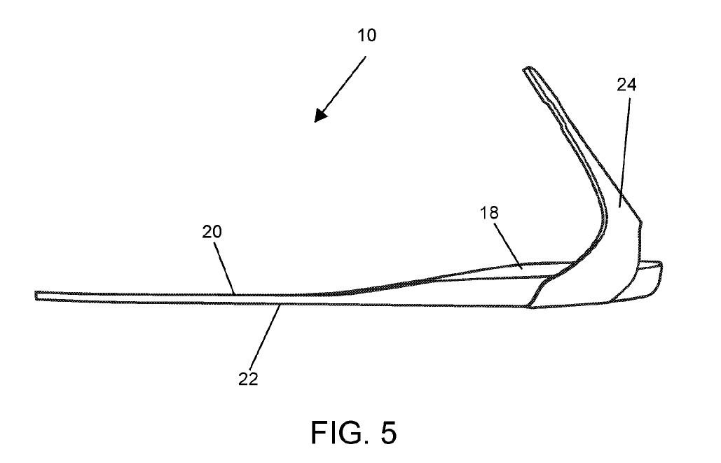

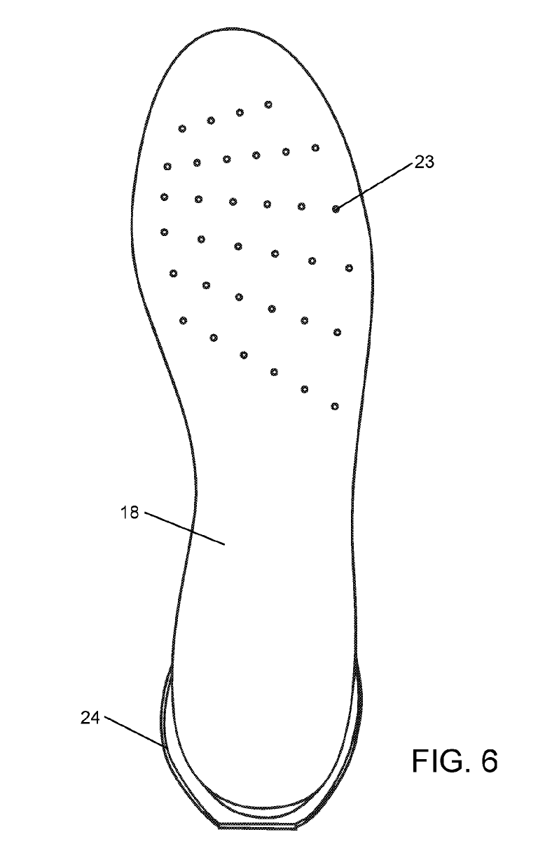

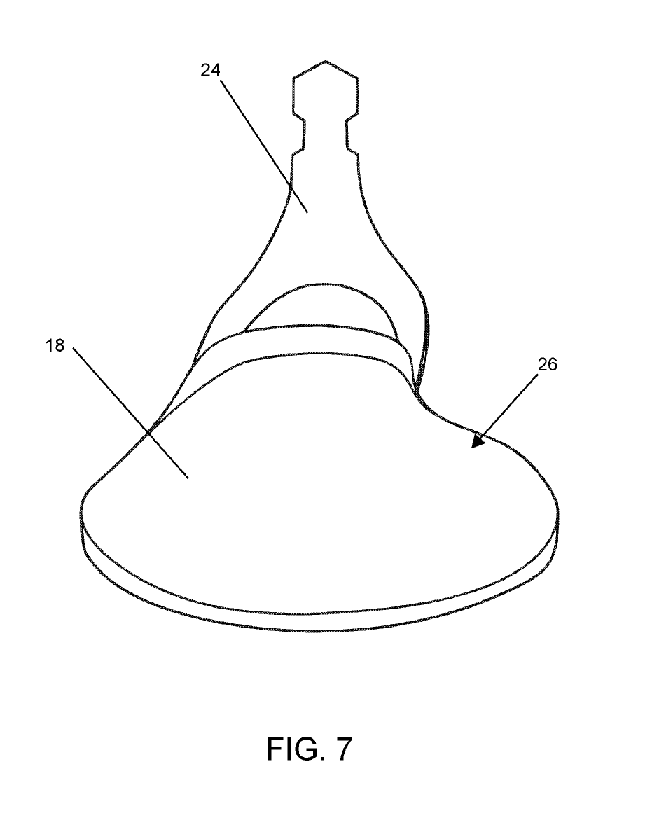

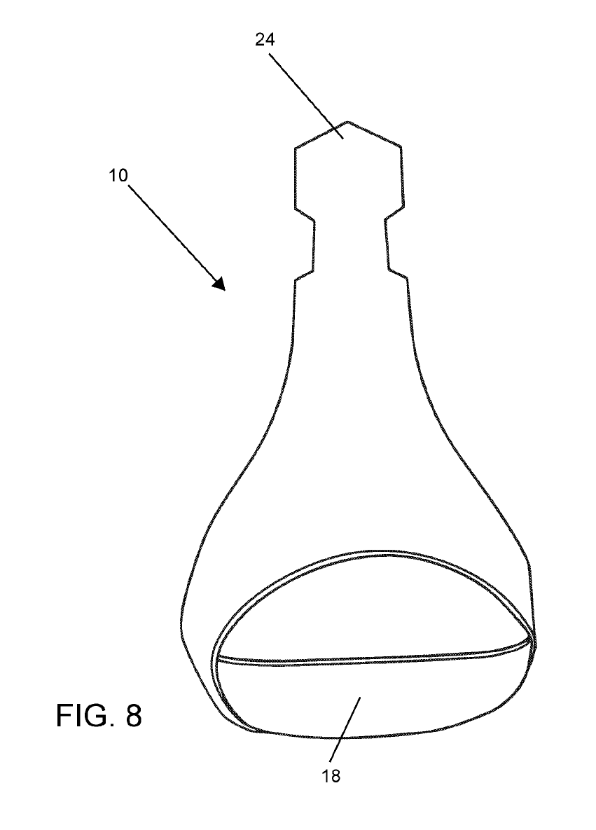

With reference now to the drawings, FIGS. 1 through 19 depict embodiments of an insole of the present invention, which is generally designated reference numerals 10, 100, grip fabric 26, 104 that can be applied to the insole 10, 100 or directly to a shoe 12 and testing parameters relating to the insole 10, 100 and grip material 26, 104 applied thereon.

FIG. 1 illustrates an athletic shoe 12 in which the insole 10 is arranged. As shown, the insole 10 substantially encompasses the entire internal base of the shoe 12.

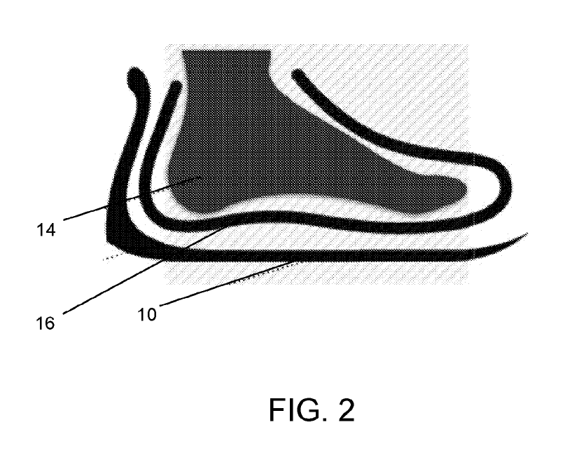

FIG. 2 is a cross-sectional view showing a foot 14 of an individual arranged within a sock 16 and the foot 14/sock 16 contactable with the insole 10.

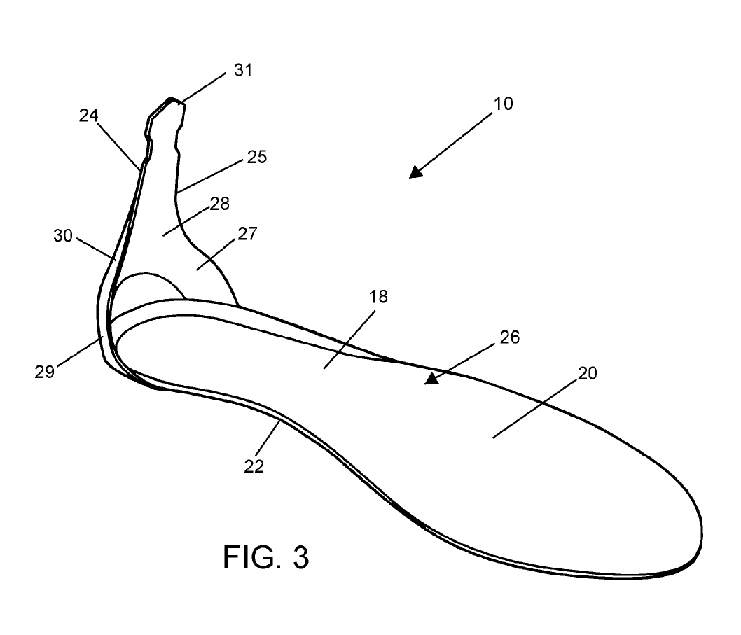

FIGS. 3-8 illustrate various views of the insole 10. The insole 10 includes a base 18 that has a top surface 20 and a bottom surface 22, a heel portion 24 that extends from the base 18 and a layer of synthetic fabric 26 that is sourced from a supplier and that has a high coefficient of friction to prevent slippage of an individual's foot within a shoe under both dry and wet conditions to ensure static contact between the insole 10 and foot or sock.

In an embodiment, the coefficient of friction for the synthetic fabric 26 is at least about 0.65μ and preferably between about 0.65μ and 0.95μ. In an embodiment, the coefficient of friction for the synthetic fabric 26 in contact with another material such as a generic sock is between about 0.65μ and 0.83μ. In an embodiment, the coefficient of friction for the synthetic fabric 26 in direct contact with skin (e.g, foot) is between about 0.74μ and 0.95μ. In an embodiment, the grip material has a thickness of less than about 2 mm and preferably less than about 1 mm.

The base 18 of the insole 10 can be comprised of a foam core, and can be perforated 23 for breathability. The heel portion 24 includes an inner surface 28 and an outer surface 30. As can be seen in FIGS. 1-8, the heel portion 24 is comprised of a main body 25, a first leg 27 that extends from a first side of the main body 25 and is affixable to the base 18 of the insole 10, a second leg 29 that extends from a second side of the main body 25 and is affixable to the base 18 of the insole 10 and a tab 31 that extends from the main body 25 of the heel portion 24, away from the base 18. As shown, for example, in FIG. 1, at least the tab 31 of the heel portion 24 extends at least partially beyond the shoe 12 body. The heel portion 24 aids to further support an individual's foot within a shoe 12 and can provide surface area for branding to be placed on at least a portion of the tab 31 that is visible when the shoe 12 is worn by an individual.

Although the synthetic fabric 26 is shown as covering the entire top surface 20 of the insole 10 and the inner surface 28 of the heel portion 24, the fabric 26 can cover only part of any surface of the insole 10 and/or heel portion 24. In an embodiment, the synthetic fabric 26 can be poly micro-suede. In an embodiment, the fabric 26 can be comprised of a combination of nylon and polyester that is neither woven nor knitted. Rather, the fabric 26 is a composite that combines nylon with polyester and includes a brushed surface with a high coefficient of friction as indicated above. In an embodiment the nylon and polyester are combined (e.g., heat pressed) to form the fabric and the combined fabric is then brushed to provide the fabric with nap.

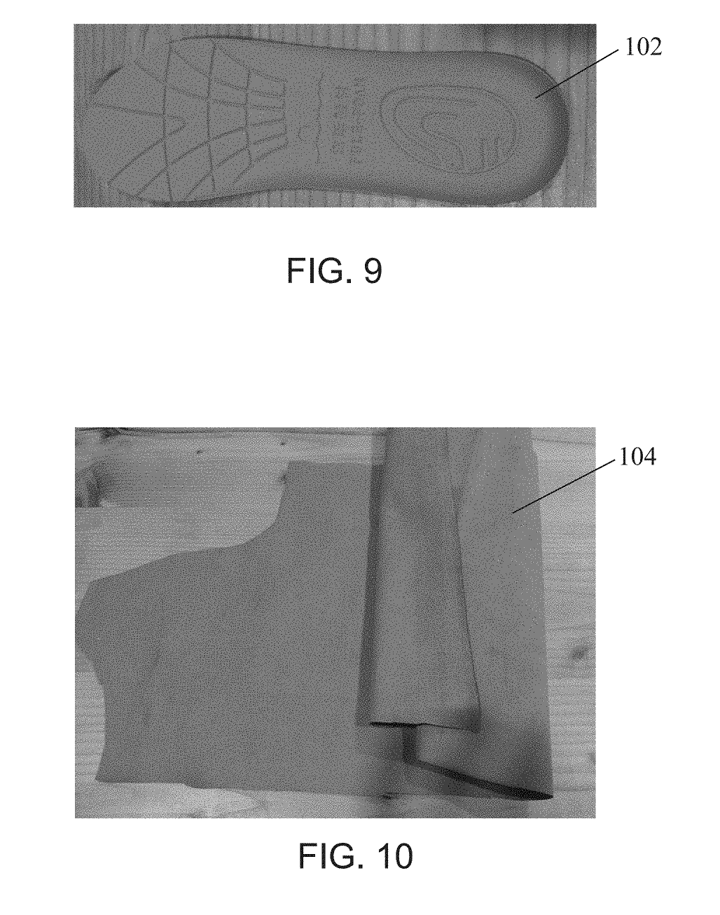

FIG. 9 illustrates an embodiment of a core or base 102 of an embodiment of an insole 100. The core 102 is comprised of polyurethane foam or sponge that is molded into an ergonomic shape. FIG. 10 depicts a sheet of synthetic fabric 104. The synthetic fabric 104 is comprised of materials that have a high coefficient of friction to ensure static contact is maintained with an individual's foot or sock worn by an individual under wet and dry conditions. An adhesive can extend over a surface of the fabric 104 to allow for the synthetic fabric 104 to be affixed to an insole 100. In an embodiment, the synthetic fabric 104 can be poly micro-suede fabric. In an embodiment, the fabric 104 can be comprised of a combination of nylon and polyester that is neither woven nor knitted. Rather, the fabric 104 is a composite material that combines nylon with polyester. In an embodiment the nylon and polyester are combined (e.g., heat pressed) to form the fabric and the combined fabric is then brushed to provide the fabric with nap.

In an embodiment, the coefficient of friction for the synthetic fabric 104 is at least about 0.65μ and preferably between about 0.65μ to 0.95μ. In an embodiment, the coefficient of friction for the synthetic fabric 26 in contact with another material such as a generic sock is between about 0.65μ and 0.83μ. In an embodiment, the coefficient of friction for the synthetic fabric 26 in direct contact with skin (e.g, foot) is between about 0.74μ and 0.95μ. In an embodiment, the fabric 104 has a thickness of less than about 2 mm and preferably less than about 1 mm.

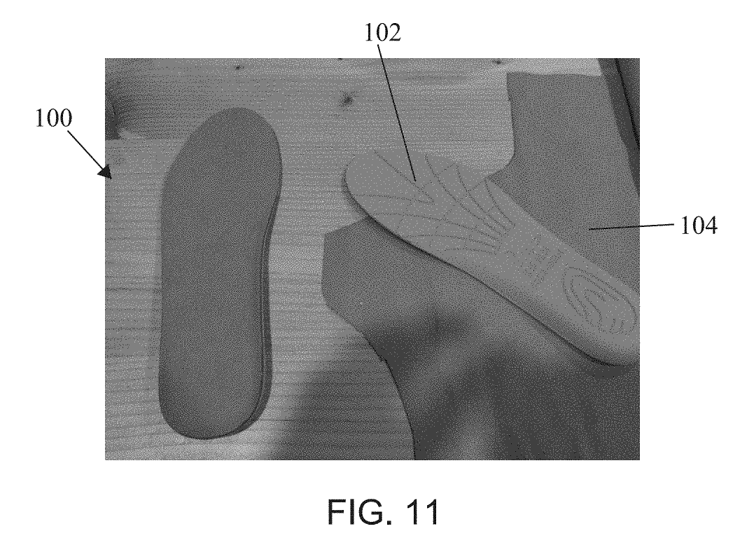

As shown in FIG. 11, the synthetic fabric 104 can be arranged to cover the entire upper surface 106 of the insole 100. In another embodiment, the synthetic fabric 104 can be arranged to cover specific upper regions of the insole 100 that are prone to slide in a shoe and/or on which weight is regularly placed thereon such as, for example, the regions of the insole 100 that commonly are contactable with the ball, heel and instep regions of an individual's foot. Due to the insole 100 having a high coefficient of friction, substantially immobile contact results between an individual's foot or a sock worn over an individual's foot and a shoe via the insole. In turn, reaction time can be increased and injuries typically caused due to movement of an individual's foot within a shoe (e.g., sprained ankle, sprained ligaments, torn ACL) can be greatly reduced. In experimental testing, the contact time using synthetic fabric 26, 104 increased reaction time by approximately 0.20 seconds.

In an embodiment, the synthetic fabric 104 can be permanently fixed over the entirety of the base 102 of the insole 100 or over a region or regions of the base 102 of the insole 100. In an embodiment, the synthetic fabric 104 can be permanently fixed by laminating the fabric 104 to the base 102 of the insole.

In an embodiment, the synthetic fabric 26, 104 can be roll, a sheet or sheets of releasably fixable synthetic fabric 26, 104 where at least a top surface of the synthetic fabric 26, 104 has a high coefficient of friction and the bottom side of the synthetic fabric 26, 104 has pressure-sensitive adhesive applied thereto with a removable covering layer extending over the adhesive. When the covering layer is removed to expose the pressure-sensitive adhesive, the strip or sheet of synthetic fabric 26, 104 can be arranged over a region, regions or the entirety of the top of the core or base 26, 104. Then, by applying pressure to the top surface of the synthetic fabric 26, 104, the grip fabric 26, 104 can be releasably fixed to the base 18, 102 of the insole 10, 100. Here, a user can both apply, remove and reapply or use a new strip or sheet of synthetic fabric 26, 104, allowing for optimal adjustment of positioning of the fabric 26, 104 for the user.

In an embodiment, the synthetic fabric 26 can be applied directly to at least one region of a shoe. For example, the synthetic fabric 26 can be applied to an internal base of a shoe, the heel of a shoe, the internal upper surface of a shoe and/or the internal sidewalls of a shoe.

In experimental testing, it has been found that the grip fabric 26, 104 significantly improves friction between an individual's foot and shoe, thereby reducing the possibility of slippage of an individual's foot within the shoe regardless of whether the conditions are wet or dry, improving reactivity. Under dry conditions, by including grip fabric 26, 104 on at least a portion of an insole 10, 100, the coefficient of friction between an individual's foot and insole increases by 48% over standard insole designs. Under wet conditions, by including grip fabric 26, 104 on at least a portion of an insole 10, 100, the coefficient of friction between an individual's foot and insole increases by 41% over standard insole designs.

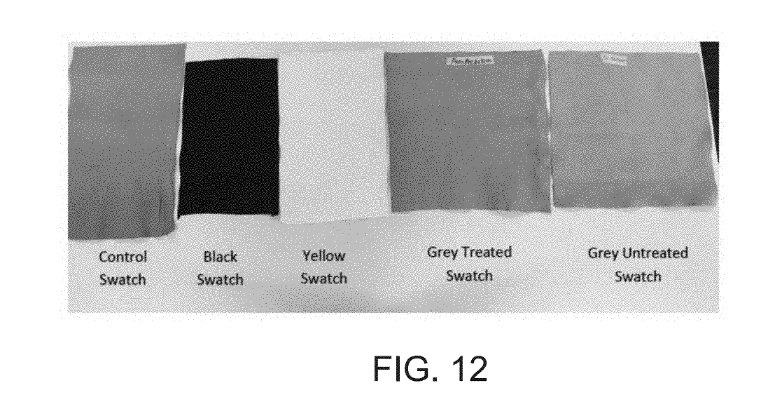

FIG. 12 depicts various versions of the grip fabric tested to assess their friction properties. Each version of the fabric contains generally the same combination of materials (nylon and polyester) that are nonwoven. One of the versions of material (Grey Treated Swatch) included an anti-microbial treatment. The other versions were untreated and varied in thickness and/or manufacturing. During testing, a weighted sled (9.95 kg) was dragged using an Instron machine with a constant velocity of 500 mm/min. over each version of grip fabric. To test the fabrics in wet conditions, each fabric, water was applied over the surface of each fabric to ensure the fabric was thoroughly wetted. Testing of both static friction (force required to initiate movement between two materials) and dynamic friction (force required to maintain motion between two materials) was conducted under dry and wet conditions. The average coefficient of friction is at least about 0.72μ.

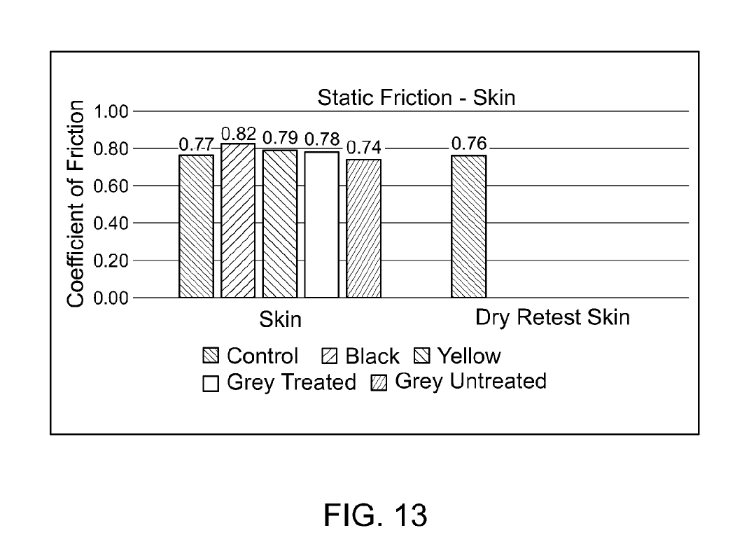

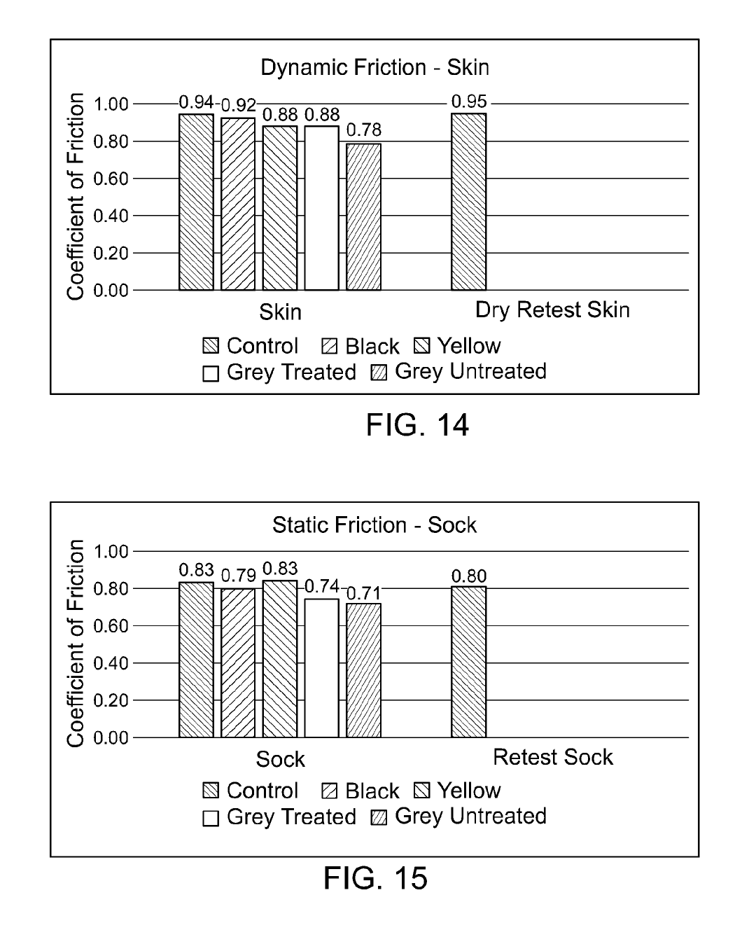

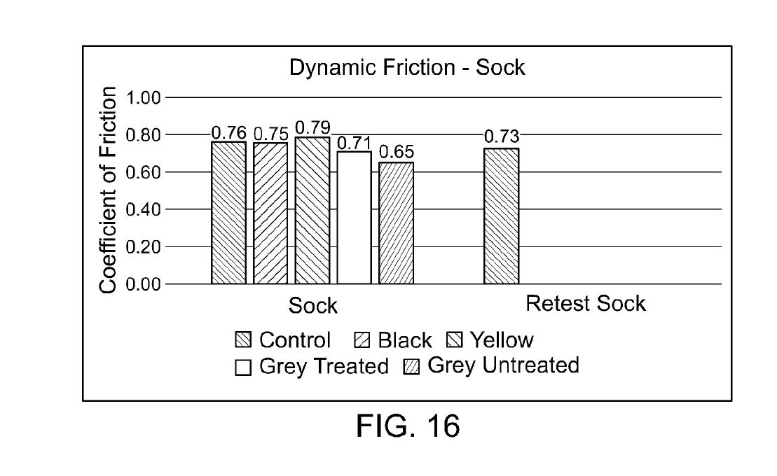

As shown in FIG. 13, when each fabric was in contact with a standard sock under wet conditions, the static coefficient of friction ranged between about 0.71μ and 0.83μ. As shown in FIG. 14, when the various versions of the fabric were tested in direct contact with skin (or a swatch having properties similar to skin) under dry conditions, the static coefficient of friction ranged between about 0.74μ and 0.82μ. As shown in FIG. 15, when each fabric was in contact with a standard sock under wet conditions, the dynamic coefficient of friction ranged between about 0.65μ and 0.79μ. As shown in FIG. 16, when the various versions of the fabric were tested in direct contact with skin (or a swatch having properties similar to skin) under dry conditions, the dynamic coefficient of friction ranged between about 0.78μ and 0.95μ.

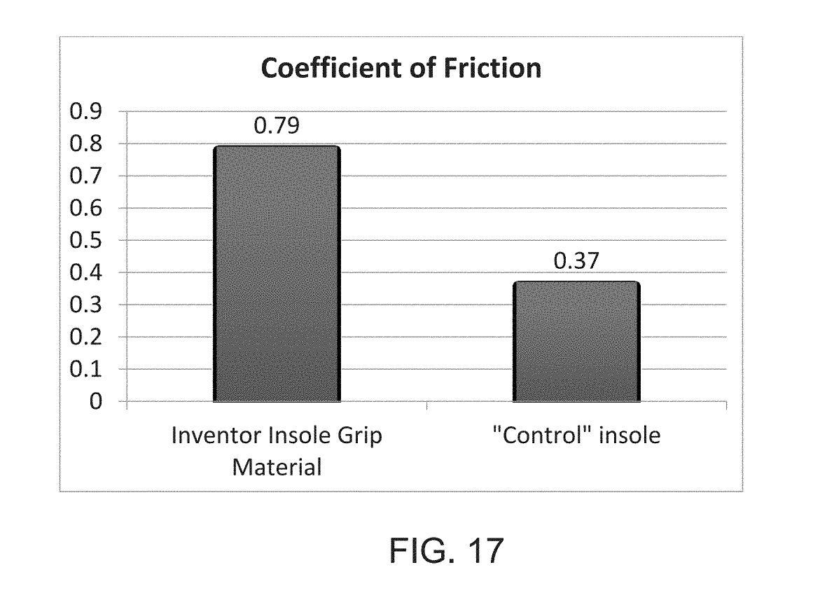

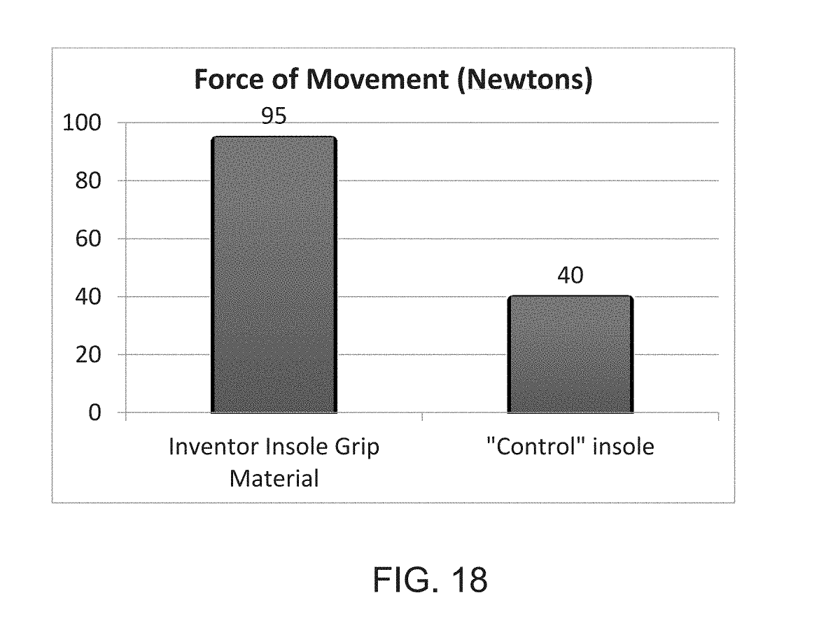

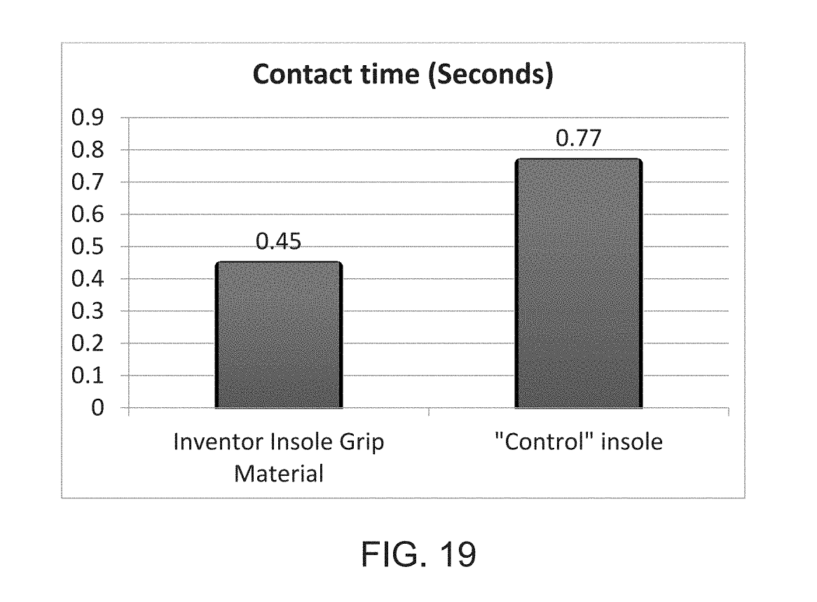

FIG. 17 shows a comparison of the coefficient of dynamic friction of an embodiment of grip material applied to an insole of the present invention versus a standard insole and the interaction between the insoles and an athletic sock. The athletic sock was comprised of about 93% polyamide and 7% elastane and the testing was performed under dry conditions. As illustrated, the grip fabric/insole of the present invention, which has a coefficient of friction of 0.79μ, shows significant improvement over existing insole designs, which has a coefficient of friction of 0.37μ. Similarly, FIG. 18 shows a comparison of the force of movement of an embodiment of grip material applied to an insole of the present invention versus a standard insole. The graph here illustrates the difference during a horizontal impulse generated when performing lateral hop movement while wearing a standard athletic sock under dry conditions. As illustrated, the force required for movement of the grip fabric/insole of the present invention is 95 Newton versus the force required for movement of an existing insole design is 40 Newton.

Finally, FIG. 19 illustrates a comparison of the contact time of the grip fabric/insole of the present invention versus an existing insole design. The test here indicates the time spent by an individual's foot wearing a standard athletic sock in contact with an insole while performing lateral movement. As shown, the contact time of the grip fabric/insole of the present invention is 0.45 seconds and the contact time of an existing insole design is 0.77 seconds. Thus, the contact time is considerably reduced, which results in increased reaction time and explosive movement of an individual.

The foregoing description and associated images illustrate several embodiments of the invention and its respective constituent parts. However, other configurations the inclusion of other materials is possible. As such, the images are not intended to be limiting in that regard. Thus, although the description above and accompanying images contain much specificity, the details provided should not be construed as limiting the scope of the embodiments, but merely as providing illustrations of some of embodiments of the present disclosure. The images and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

What is claimed is:

1. An insole, comprising:
a base including a top surface and a bottom surface; and
grip fabric having a coefficient of friction of at least about 0.65μ fixed at least along a portion of the top surface of the base to prevent slippage.

2. The insole of claim 1, wherein the grip fabric is comprised of a combination of brushed nylon and polyester.

3. The insole of claim 1, wherein a static coefficient of friction for the grip fabric in contact with skin conditions is between about 0.74μ and 0.82μ and a sock is between about 0.71μ and 0.83μ.

4. The insole of claim 1, wherein a dynamic coefficient of friction for the grip fabric in contact with skin is between about 0.78μ and 0.95μ and a sock is between about 0.65μ and 0.79μ.

5. The insole of claim 1, further comprising an adhesive material applied to a surface of at least one of the base and the grip fabric so that the grip fabric is affixable to the base.

6. The insole of claim 1, wherein the portion of the top surface of the base upon which the grip fabric is applied include those contactable with the ball, heel, instep, top and side regions of a foot.

7. The insole of claim 1, wherein the grip fabric extends over the entire upper region of the base.

8. The insole of claim 1, further comprising a heel portion extending from the base of the insole.

9. The insole of claim 8, wherein the grip fabric extends at least in part over a surface of the heel portion.

10. A method of forming an insole, comprising:
molding a base into an ergonomic shape;
cutting grip fabric that has a coefficient of at least about 0.65μ into at least one desired shape; and
affixing the grip fabric along at least a portion of an upper surface of the base.

11. The method of claim 10, wherein the grip fabric is comprised of a combination brushed polyester and nylon.

12. The method of claim 10, further comprising affixing adhesive material to at least one of the grip fabric and base to releasably affix the grip fabric to the base.

13. The method of claim 10, wherein the grip fabric is laminated on the base.

14. The method of claim 10, wherein the regions of the upper surface upon which the grip fabric is applied include those contactable with the ball, heel and instep regions of a foot.

15. The method of claim 10, wherein the grip fabric extends over the entire upper region of the base.

16. The method of claim 10, further comprising a heel portion that includes a body, a first leg extending from the body.

17. The method of claim 16, further comprising the step of affixing the grip fabric onto at least regions of a surface of the heel portion.

18. A shoe assembly, comprising:
a shoe; and
a layer of grip fabric comprised of a combination of non-woven brushed polyester and nylon having a coefficient of friction of at least about 0.65μ that is directly affixable to at least a portion of one of the base, the sidewalls, the heel and the upper surface of the shoe.
